(19) United States
(12) Patent Application Publication
(10) Pub. No.: US 2014/0063575 A1
(43) Pub. Date: Mar. 6, 2014

(54) MULTI-RESOLUTION SEGMENTED IMAGE SENSOR

(71) Applicants: Stacy M. Munechika, Fairport, NY (US); Christopher B. Liston, Rochester, NY (US)

(72) Inventors: Stacy M. Munechika, Fairport, NY (US); Christopher B. Liston, Rochester, NY (US)

(21) Appl. No.: 13/599,119

(22) Filed: Aug. 30, 2012

(51) Int. Cl. H04N 1/46

(52) U.S. Cl. 358/502

(57) ABSTRACT

A multi-resolution imaging device (10) for a high-speed multi-color printer includes at least one high resolution sensor (20), wherein an output of the high resolution sensor is transmitted to a controller (19); at least one low resolution sensor (24); wherein the controller calculates a correction for stitch; wherein the controller, based on the calculated correction, adjusts a timing of image data provided to imaging inkjets (12) to aligned an output of the inkjets; and wherein the low resolution sensor provides full page viewing.

### CROSS REFERENCE TO RELATED APPLICATIONS

Reference is made to commonly-assigned copending U.S. patent application Ser. No. ______ (Attorney Docket No. K001225US01NAB), filed herewith, entitled MULTI-RESOLUTION SEGMENTED IMAGE SENSOR, by Munechika et al.; the disclosure of which is incorporated herein.

### FIELD OF THE INVENTION

The present invention relates in general to printing and in particular to low resolution and high resolution sensors for multi-head printers.

### BACKGROUND OF THE INVENTION

In large print systems multiple calibrations are performed by sensing the position of printed marks and making adjustments based on the results of these measurements. Often multiple sensors are employed to perform each of the calibrations because the required qualities of the sensors, for example, resolution, differ from application to application.

In a print system with wide receivers it is often necessary to align multiple print elements so they can function as one wide element to span the width of the receiver. For example, in large inkjet printers, multiple 6″ wide lineheads are combined to print on 19″ or 25″ wide paper. Since the lineheads cannot be mounted end to end they are offset from each other in the direction of media travel. To print a straight line of data on the paper, the printing on each linehead must be enabled at different times so that the image is printed in alignment on the receiver. This timing adjustment produces alignment in the direction of media travel.

Due to mechanical tolerances, there must be a certain amount of overlap between lineheads in the cross travel direction. Alignment in the cross travel direction is achieved by selecting the printing elements on which one linehead stops printing and the next linehead starts printing. A method to align the lineheads is to print marks from each linehead, measure the marks, and adjust the exposure timing and overlap pixel for optimal printing. A common method to do this is to use high resolution digital cameras to measure marks from each linehead and make the adjustments.

For a high quality print all the color planes should be printed directly on top of each other. Any error is called misregistration and is unacceptable. To maintain good registration the positions of the colors are measured regularly and adjusted. A final group of functions include the detection of defects such as streaks or missing lines of data and the visualization of images as they are printed.

Current implementations use multiple sensors for these functions. For example, multiple high resolution cameras with small fields of view can be used for the first two functions while a line array with a wide field of view can be used for the third function. It is not practical to acquire the full width at high resolution because it becomes very expensive to handle the large amount of high speed data.

### SUMMARY OF THE INVENTION

Briefly, according to one aspect of the present invention, a multi-resolution imaging device for a high-speed multi-color printer includes at least one high resolution sensor. An output of the high resolution sensor is transmitted to a controller and the controller calculates a correction for stitch and aligns an output of the inkjets. A low resolution sensor provides full page viewing for other defects.

This invention presents a novel method and apparatus to combine sensors for multiple control functions. Specifically, this invention provides a means of combining the sensors needed for alignment of the image writer sections (stitch), control of color to color registration, and defect detection and page visualization.

The invention and its objects and advantages will become more apparent in the detailed description of the preferred embodiment presented below.

### BRIEF DESCRIPTION OF THE DRAWINGS

FIG. 1 is a schematic view of a multi-resolution segmented image sensor according to the present invention.

FIG. 2 is a plan view showing printing modules and sensor array according to an embodiment of the present invention.

FIG. 3 is a schematic view of a multi-resolution image sensor according to the present invention.

FIG. 4 is a plan view, partially in phantom, of the present invention with a lens array.

FIG. 5 is a plan view of the present invention showing an inline sensor array.

FIG. 6A is a schematic showing the data flow arrangement with respect to the multi-resolution image sensor with the low-resolution sensor offset from the high-resolution sensors.

FIG. 6B is a schematic showing the data flow arrangement with respect to the multi-resolution image sensor with the high-resolution sensors positioned in-line with the low-resolution sensors.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

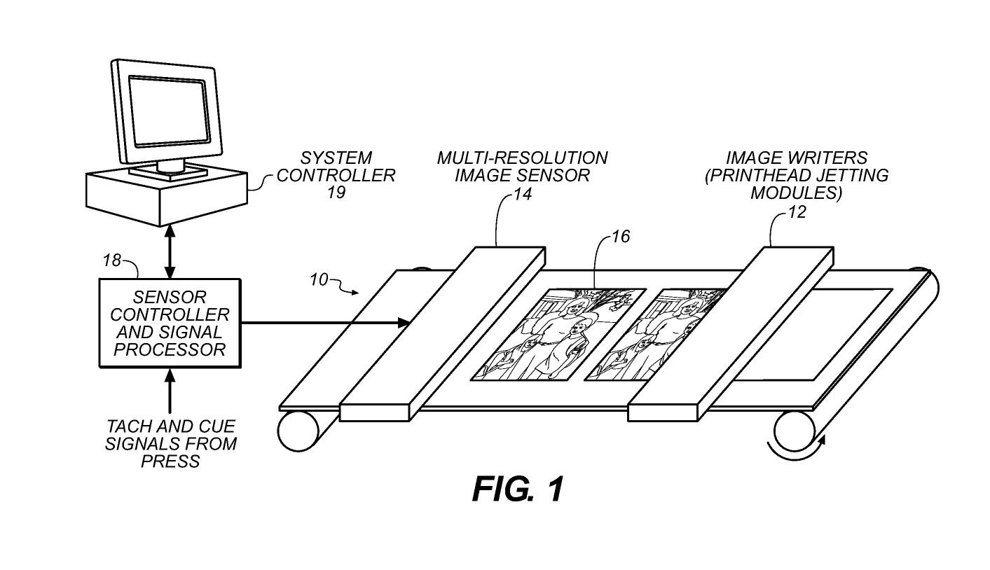

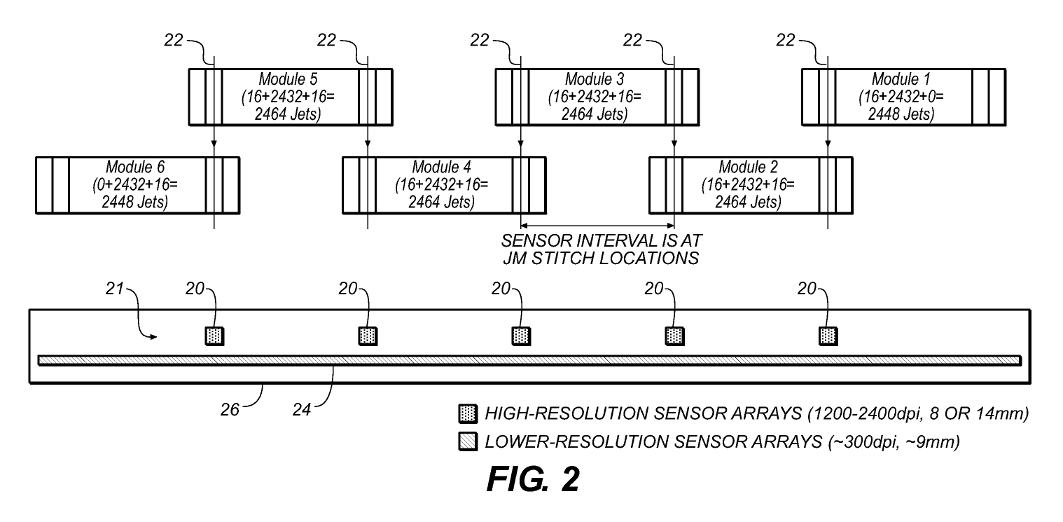

Referring now to FIG. 1 diagrammatically illustrates an ink jet printer 10 with associated jetting modules 12 for printing images 16, and a multi-resolution image sensor (MRIS) 14. The MRIS is oriented to provide full coverage of the printed substrate 16 width as the printed substrate traverses across the MRIS sensing elements 20, shown in FIG. 2. Tach and cue signals from the press machine-control electronics, not shown, provide synchronizing signals to initiate the scanning operation of the MRIS commensurate with a known starting location of the printed substrate.

In one embodiment, the MRIS is comprised of a segmented array of charged-couple devices (CCDs) 20, shown in FIG. 2, that have varying native resolution and are arranged on a common substrate. Electronic data from the MRIS are sent to the sensor controller and signal processor 18, shown in FIG. 1, which relays the processed data to a system controller 19 which utilizes the data for performing writing system (jetting module) adjustments and image display of the printed image.

FIG. 2 depicts an arrangement wherein high-resolution scanning elements 20 form a CCD array 21 (e.g. 1200 dpi) and are linearly arranged in a non-contiguous manner at the jetting-module stitch locations 22. FIG. 2 also shows a contiguous linear arrangement of lower resolution CCD sensors (e.g. 300 dpi) 24 that are in close proximity and arranged parallel to the non-contiguous, high-resolution CCD arrays 20. The arrangement of the lower-resolution CCD arrays is such that the pitch between adjacent elements is constant (e.g. 84.67 microns for 300 dpi). This pitch is maintained across adjacent CCD arrays such that all elements along the active length of the arrays appear at the same resolution with minimal linearity error in the x, y and z directions. In the preferred embodiment, the CCD arrays are bonded to a common substrate material 26 using known die-bonding techniques. The substrate material can be ceramic or a dimensionally stable fiberglass printed-circuit-board substrate material (e.g. FR-4). Appropriate wirebonding techniques can be used to connect the CCD sensors to the conductive traces on the substrate, which in turn connect to the CCD driving circuitry and signal-processing electronics.

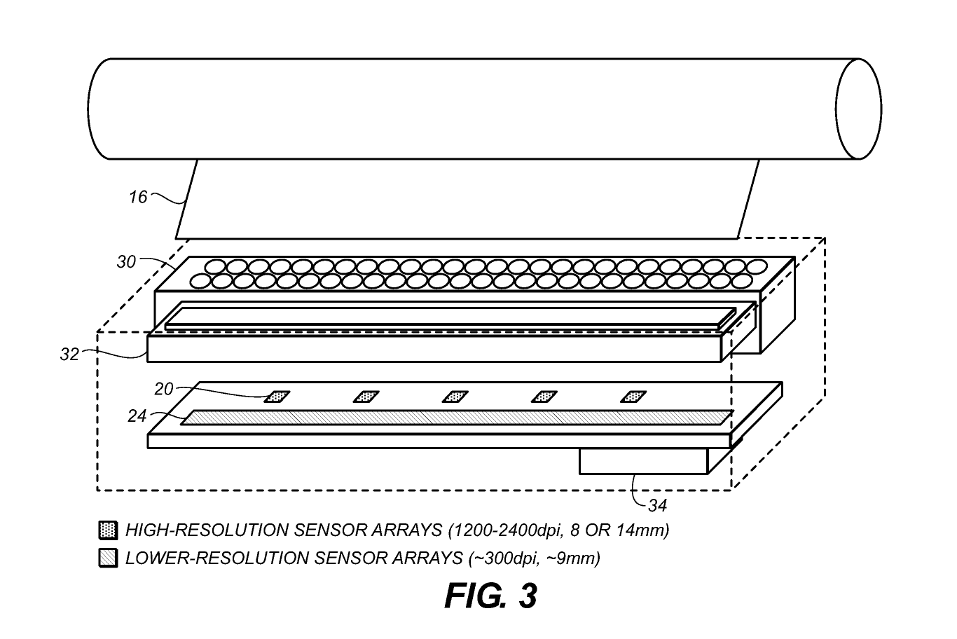

FIG. 3 is a schematic of a multi-resolution image sensor according to the present invention. The use of Selfoc™ gradient-index lenses 30 in the optical design of linear CCD sensors is well known in the scanner industry e.g. industrial contact-image sensor (CIS) technology produced by Tichawa. A common line-illumination source 32 is also positioned to allow for sufficient target illumination along a scan line within the field of view of the CCD sensors. The line-illumination source can be monochromatic, or RGB with associated strobe timing circuitry to allow for activation of the various light sources at the appropriate time. The interface electronics circuitries 34 are used to control the sensor data and relay the acquisition timing from the sensor controller 18. In one embodiment, interface circuitry 34 is compliant with standard camera sensor interface protocols such as CameraLink.

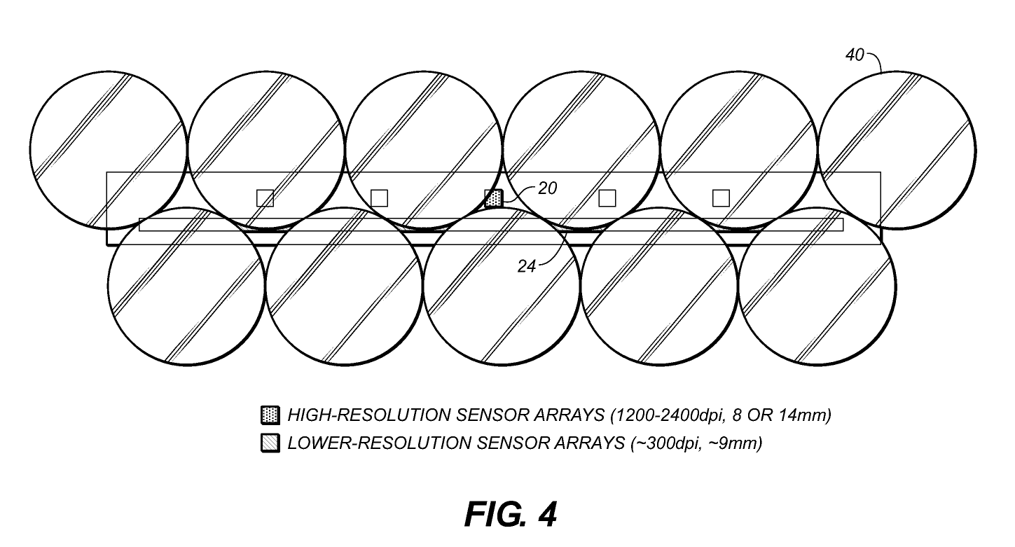

FIG. 4 is a schematic top view of the present invention with a Selfoc™ lens array 30. The separation between the two rows of CCDs is consistent with the field-of-view of the imaging optics such that both sensor rows can be imaged adequately with a common optics such as a Selfoc™ lens 40 made by Nippon Sheet Glass (NSG). The Selfoc lens has a plurality of gradient-index glass rods that are packed and arranged to produce a compact lens that can image the linear arrangement of CCD arrays in a 1:1 magnification ratio with a fixed working distance from the lens to the image plane

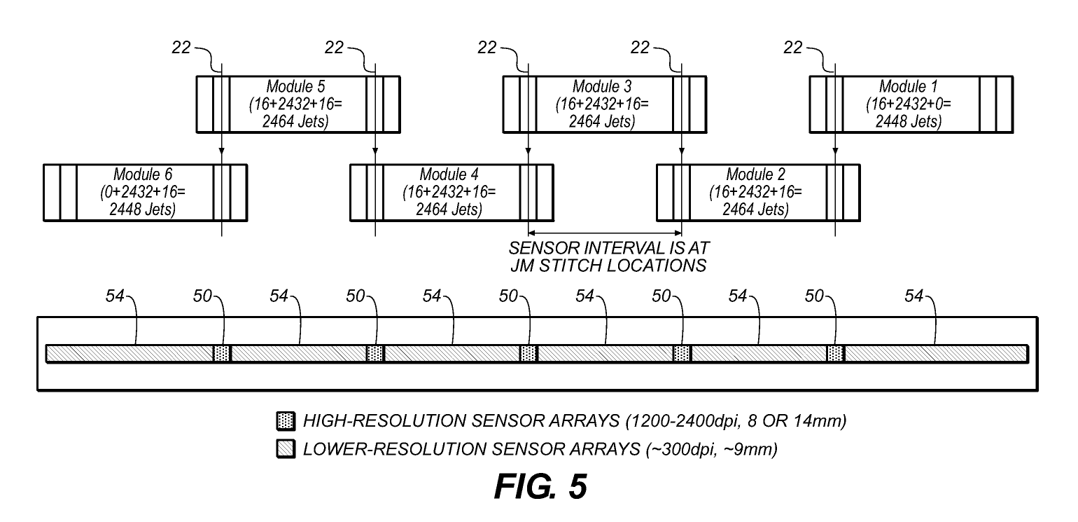

In another embodiment, shown in FIG. 5, the higher 50 and lower 54 resolution arrays are arranged in a single, inline or collinear configuration on a common substrate 26. The higher-resolution sensors 50 are positioned at the jetting-module locations 22, but in a contiguous arrangement with the lower-resolution arrays.

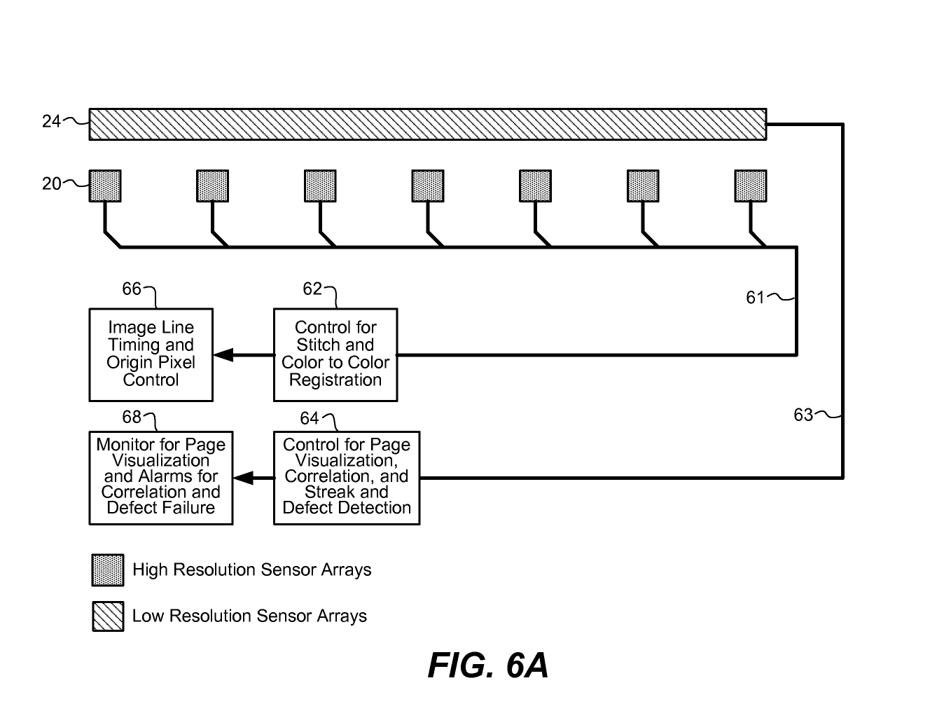

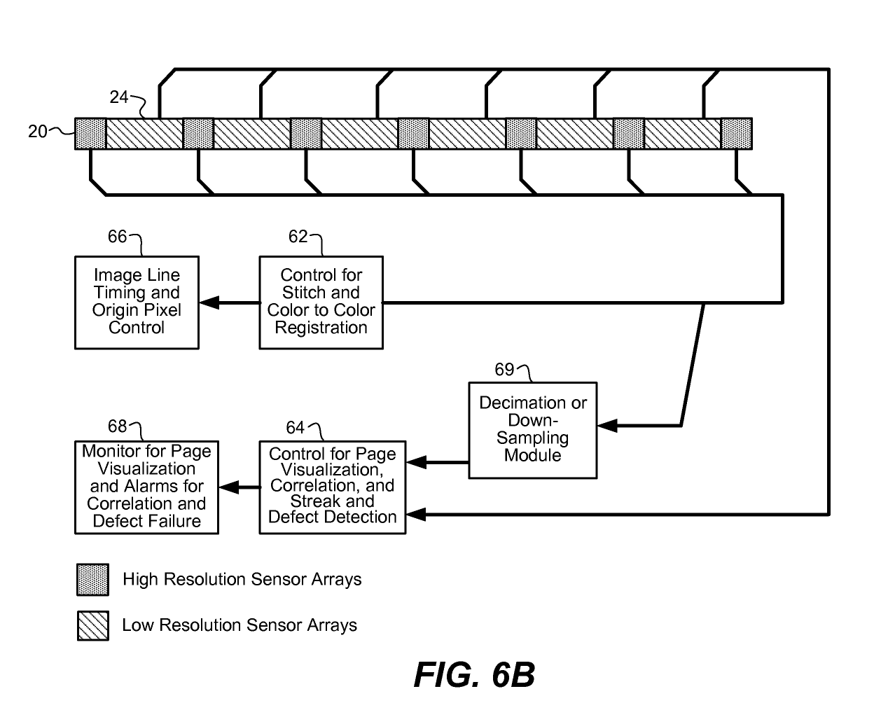

As shown in FIG. 6A, each row of CCD arrays has a separate output channel that may also be segmented into multiple channels (61, 63) depending on the required bandwidth needed for the image-acquisition process. The CCD output channels are load-balanced to allow similar data-acquisition rates for each channel. The higher-resolution array channel 61 minimizes the data bandwidth by not having contiguous arrays along the entire imaging width. Conversely, the lower-resolution arrays provide continuous coverage, but also minimize data bandwidth requirements by having fewer pixels per unit length than the higher-resolution arrays. The multiple CCD output channels enable simultaneous scanning at full speed of both the higher-resolution arrays and the lower resolution arrays. FIG. 6B shows an alternative configuration where the high-resolution and low-resolution sensors are positioned in an inline or collinear fashion. The data channels are still arranged as the previous configuration shown in FIG. 6A.

The output from the CCD output channels are sent to signal-processing circuitry 34, shown in FIG. 1, that provides A/D conversion, combines and manipulates the data in each channel such that the output from the signal-processing block is usable image data for image analysis.

In the inline configuration of the higher and lower resolution arrays, appropriate signal processing 69, shown in FIG. 6B, is used to extract a lower-resolution image segment from the higher-resolution arrays and concatenate this image segment to the image data from the lower-resolution arrays.

The system controller 19, shown in FIG. 1, contains the functions needed for control for stitch and color-to-color registration 62, control for page visualization, page correlation, and streak and defect detection 64, image line timing and origin pixel control 66. The controller 19 also has a monitor for page visualization and a graphical display of alarms in the case of correlation and defect failures 68.

The invention has been described in detail with particular reference to certain preferred embodiments thereof, but it will be understood that variations and modifications can be effected within the scope of the invention.

### PARTS LIST

10 multi-resolution imaging device (inkjet printer)
12 jetting module
14 multi-resolution image sensor (MRIS)
16 output print
18 sensor controller and signal processor
19 system controller
20 sensing elements (CCDs)
21 high-resolution sensing array(s) (CCD array)
22 jetting module stitch location(s)
24 low-resolution CCD sensing array(s)
26 substrate material
30 gradient-index lens array
32 illumination light source
34 sensor electrical interface and signal processing
40 top view of gradient-index lens array
50 high-resolution sensing array(s)
54 low-resolution sensing array(s)
61 channel
62 control for stitch and color-to-color registration function block
63 channel
64 control for page visualization, correlation and streak and defect detection function block
66 image line timing and origin pixel control function block
68 monitor for page visualization and alarms
69 decimation or down-sampling module function block

1. A multi-resolution imaging device for a high-speed multi-color printer comprising:
a plurality of jetting modules (print elements) to print across a width of a receiver medium, the plurality of jetting modules have one or more stitch locations;
at least one high resolution sensor array, wherein an output of the high resolution sensor array is transmitted to a controller;
at least one low resolution sensor array, wherein an output of the low resolution sensor array is transmitted to a controller;
wherein the controller calculates a correction for stitch;
wherein the controller, based on the calculated correction, adjusts a timing of image data provided to imaging inkjets to aligned an output of the jetting modules; and
wherein the low resolution sensor provides full page viewing.

2. The multi-resolution imaging device of claim 1 wherein the low resolution sensor detects registration at an edge of a media.

3. The multi-resolution imaging device of claim 1 wherein the high resolution sensor detects image artifacts.

4. The multi-resolution imaging device of claim 1 wherein the high resolution sensor and the low resolution sensor are in a staggered configuration.

5. The multi-resolution imaging device of claim 1 wherein the high resolution sensor and the low resolution sensor are in an in-line configuration.

6. The multi-resolution imaging device of claim 1 wherein the data rate on the high resolution sensor is limited.

7. The multi-resolution imaging device of claim 1 wherein high resolution sensors are cascaded to provide a limited number of data channels.

8. The multi-resolution imaging device of claim 1 wherein the high resolution sensor and the low resolution sensor are bonded to a substrate that translates in a cross-track direction for alignment.

9. The multi-resolution imaging device of claim 1 wherein the printer is an inkjet printer.

10. The multi-resolution imaging device of claim 1 wherein the image writer is an inkjet module.

11. The multi-resolution imaging device of claim 1 wherein the sensor only scans portions of an imaging width.

12. The multi-resolution imaging device of claim 1 manipulates the output from the high resolution sensors and the low resolution sensors to produce image data for image analysis.

13. The multi-resolution imaging device of claim 2 extracts a lower-resolution image segment from the image data of the higher-resolution arrays and concatenating this image segment to the image data from the lower-resolution arrays to produce a usable image data for image analysis.

14. The multi-resolution imaging device of claim 1 wherein the high resolution sensor arrays are positioned at or aligned with the jetting module stitching locations.
